(19) United States
(12) Patent Application Publication
(10) Pub. No.: US 2025/0296594 A1
(43) Pub. Date: Sep. 25, 2025

(54) PEDESTRIAN PREDICTION SYSTEMS AND METHODS FOR AUTONOMOUS VEHICLES

(71) Applicant: Moovita Pte Ltd, Singapore (SG)

(72) Inventors: Kendrick AMEZQUITA-SEMPRUN, Singapore (SG); Matthew YAP, Singapore (SG); Chern Yuen Anthony WONG, Singapore (SG); Keng Peng TEE, Singapore (SG); Banghyon LEE, Austin, TX (US); Dilip Kumar LIMBU, Singapore (SG)

(21) Appl. No.: 19/086,078

(22) Filed: Mar. 20, 2025

Related U.S. Application Data
(60) Provisional application No. 63/567,446, filed on Mar. 20, 2024.

(51) Int. Cl. B60W 50/14; B60W 30/09; B60W 30/095; B60W 60/00; G01S 17/86; G01S 17/931

(52) U.S. Cl. CPC B60W 50/14; B60W 30/09; B60W 30/0956; B60W 60/0017; B60W 60/00274; G01S 17/86; G01S 17/931; B60W 2420/403; B60W 2420/408; B60W 2554/4029; B60W 2554/4042; B60W 2554/4044; B60W 2554/4046; B60W 2556/10

(57) ABSTRACT

A system for collision avoidance by an autonomous vehicle (AV) is disclosed. The system includes a sensor system to detect objects in the AV's proximity. The system also includes a pedestrian trajectory prediction (PTP) system with an input module to receive sensor data, including heatmap prior information about past pedestrian trajectories. A memory module stores the data, and a probabilistic motion model (PMM) module uses a dynamic polar occupancy grid to represent the pedestrian's predicted trajectory. The PMM calculates occupancy probabilities based on angular motion (related to heading) and radial motion (related to speed). A processing module combines these probabilities to predict the pedestrian's future position. If an imminent collision is detected, the system generates a warning signal output to the AV's user interface. This system enhances collision avoidance by combining past data and real-time sensor data with probabilistic trajectory predictions.

### CROSS-REFERENCE TO RELATED APPLICATION

This application claims the benefit of U.S. Provisional Application Ser. No. 63/567,446, filed on Mar. 20, 2024, which is all herein incorporated by reference in its entirety for all purposes.

### FIELD OF THE INVENTION

The present disclosure generally relates to autonomous vehicles. In particular, the disclosure relates to effective pedestrian trajectory prediction systems and methods for collision avoidance by autonomous vehicles.

### BACKGROUND

Autonomous Vehicle (AV) technology has progressed significantly over the last decade to the point where AVs have started deployment as people movers under a well-defined operational design domain (ODD). However, significant social and technological challenges have prevented a broader and faster adoption of the technology.

Road users sharing a common space with the AVs are increasingly affected by the broader adaptation of AVs. To safely deploy AVs, it is necessary to reliably estimate and understand all road users' interactions. Any misinterpretation of the human road user's actions may lead to fatalities or significant property damage.

Estimating and understanding the interaction among all road users requires a robust and reliable workflow for detecting them and predicting their trajectories. This task is challenging because of how erratic human behavior can be and the complexity of their social interaction.

Pedestrians, being one of the most vulnerable road users, are a key safety consideration factor for the deployment of AVs. Knowing the pedestrians' position in the future is a key input to the AV's decision-maker and motion planner. Predicting the future trajectory of pedestrians in the vicinity of the AVs allows the latter to react safely to them.

Conventional systems for predicting the trajectory of pedestrians in the vicinity of AVs are based either on a black box model or a white box model.

Black box models encompass everything from deep learning solutions, such as transformers and neural networks to models like gradient boosting algorithms or support vector machines. Black box models typically require large amounts of past data on pedestrians for training or learning. As a result, black box models generally tend to provide higher accuracy and can identify complex relationships between different parameters. However, due to the complexity of the black box models, they are less interpretable and thus less understandable.

On the other hand, white box models are typically derived from the laws of physics and generally have two main component models: the dynamic model and the kinematic model. The dynamic and kinematic models work together to predict the pedestrian's trajectory given a certain scenario. In contrast to the methodologies following a black box approach, white box modeling requires a small amount of data to fine-tune certain parameters. White box models, although more interpretable, are less accurate.

The present disclosure is directed to pedestrian trajectory prediction systems and methods with high accuracy and interpretability.

### SUMMARY

The disclosure, in one embodiment, relates to a system for collision avoidance by an autonomous vehicle (AV). The system includes a sensor system for detecting objects in the proximity of the AV. The sensor system includes a processing module for processing sensor information from sensor modules. The system also includes a pedestrian trajectory prediction (PTP) system for predicting a trajectory of a pedestrian. The PTP system includes an input module. The input module is configured to receive input information captured by the sensor system. The input information also includes a heatmap prior information. The heatmap prior information includes a past dataset of a pedestrian's trajectory tendencies. The PTP system also includes a memory module configured to store the input information. The PTP system also includes a probabilistic motion model (PMM) module configured with a PMM. The PMM includes a dynamic polar occupancy grid where the predicted trajectory of the pedestrian is represented by an occupancy probability of cells in the polar grid calculated based on an angular motion probability related to a pedestrian's heading and a radial motion probability related to a pedestrian's speed and a distance the pedestrian is predicted to move from a current position. A predicted position of the pedestrian can be determined by combining the angular and radial motion probabilities. The PTP system further includes a processing module. The processing module retrieves the information stored in the memory module and processes it using the PMM of the PMM module and generates a warning signal output by an output module to a user interface of the AV if there is an imminent collision with the pedestrian's trajectory.

These and other advantages and features of the embodiments herein disclosed will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, with emphasis instead generally being placed upon illustrating the principles of the invention. In the following description, various embodiments of the present invention are described with reference to the following drawings, in which:

FIG. 1a shows a simplified autonomous vehicle equipped with a pedestrian trajectory prediction (PTP) system;

FIG. 1b shows an embodiment of a PTP system;

FIG. 2 shows a polar occupancy grid of a probabilistic motion model for pedestrians;

FIG. 3 illustrates an exemplary embodiment of a probability distribution;

FIG. 4 illustrates an example of obstacle constraint; and

FIGS. 5a-5d show a process flow of an embodiment of a probabilistic motion model (PMM).

### DETAILED DESCRIPTION

Embodiments relate to systems and methods for accurate pedestrian trajectory prediction with high interpretability for collision avoidance by AVs. The pedestrian trajectory prediction is based on a probabilistic motion model (PMM) for pedestrians. The PMM includes a polar occupancy grid to predict the future position of pedestrians. The PMM assumes that the pedestrians will maintain their speed and heading unless a contextual or external factor forces a change. Such contextual or external factor can be a repelling or an attraction force. For example, an obstacle blocking some of the grid's cells is a repelling force away from them or the proximity to a zebra crossing (crosswalk) is an attraction force towards the cells overlapping with it.

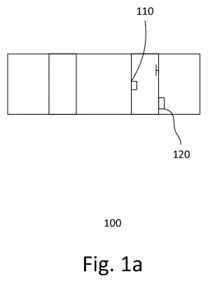

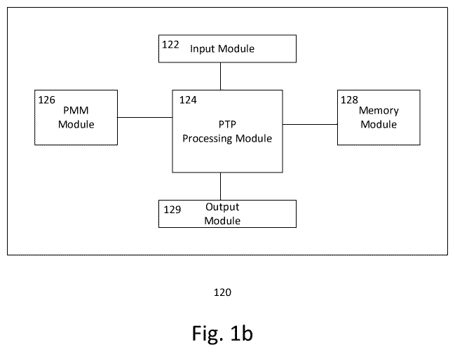

FIG. 1a shows a simplified AV 100 equipped with a pedestrian trajectory prediction system 120. The vehicle (equipped vehicle), as shown, includes a sensor system 110 for detecting objects in the proximity of the vehicle. The sensor system, for example, includes a light detection and ranging (LiDAR) and camera modules for detecting objects in the proximity of the vehicle. The sensor system may also include other types of sensor modules.

The sensor system may also include a processing module for processing sensor information from the sensor modules. For example, the sensor information includes objects in the proximity of the vehicle. The processing module is configured to identify and categorize the type of objects detected. For example, objects are categorized as pedestrians, vehicles, as well as other categories. Furthermore, objects can be categorized as obstructions. For example, obstructions are non-movable objects. In addition, the sensor system can provide perception information of pedestrians, such as heading and speed of the pedestrians. Other information may also be provided by the sensor system.

Object information, including perception information of pedestrians, captured by the sensor system is communicated to a pedestrian trajectory prediction (PTP) system 120. The PTP system is configured to predict the trajectory of the detected pedestrians within the object information. In one embodiment, the PTP system employs a probabilistic motion model (PMM) to predict the trajectory of the pedestrians.

The vehicle may include other systems for the functioning of the AV. In addition, the vehicle may include a GPS map system, which can provide navigation information, and a localization system with map information, which provides contextual data to assist pedestrian trajectory prediction by the PTP system.

FIG. 1b shows an embodiment of a PTP system 120. As shown, the PTP system includes an input module 122, a processing module 124, a PMM module 126, a memory module 128 and an output module 129. Providing the PTP with other types of modules may also be useful.

In one embodiment, the input module is configured to receive input information required by the PTP. Such input information may include, for example, detected object information from the sensor module, contextual information from the localization system, such as obstacles, including lights, lamps, sign poles, buildings and street information, such as crosswalks and intersections, as well as other contextual information.

Input information may also include heatmap prior information. A heatmap prior is derived from or constructed from a past dataset of pedestrians indicating trajectory tendencies, such as moving toward high pedestrian traffic areas and away from low pedestrian areas. This type of heatmap prior is based on an assumed data set which results in a uniform distribution. In other cases, the heatmap prior may be based on the actual movement of pedestrians. The heatmap prior can be processed and updated offline based on past data and stored for later use by the PTP system. The heatmap prior can increase the accuracy of the PTP system. Other types of information used by the PTP system may also be received by the input module. Other information, such as map-related information that produces attracting force or repelling force, such as construction zones/areas, can be updated offline to further increase prediction accuracy.

The memory module may be configured to store the input information. For example, information received by the PTP system may be stored in the memory module. The PMM module is configured with the PMM which is used to predict the trajectory of detected pedestrians. The processing module retrieves the information stored in the memory module and processes it using the PMM of the PMM module to predict the trajectory of detected pedestrians.

The predicted trajectories of the pedestrians are analyzed with respect to the equipped (Ego) vehicle to determine if there is an imminent collision with a pedestrian's trajectory. The processing module generates a warning signal which is output by the output module. The warning signal causes a user interface system of the AV to generate an alarm. The alarm can be an audio alarm with a written message displayed on the user interface system. In addition, or alternatively, the alarm signal may cause the AV control system to cause the AV to slow down and stop to avoid a collision. For example, if the pedestrian is very close to colliding with the Ego AV, hard braking may be initiated. If the pedestrian is not as close, the control system may initiate slowing the vehicle down. Other types of warnings or actions triggered by the alarm signal may also be useful.

As discussed, the PTP system predicts the trajectory of a pedestrian. The predicted trajectory of a pedestrian, in one embodiment, is represented by a polar occupancy grid. In one embodiment, each pedestrian's predicted trajectory is represented by the pedestrian's individual polar occupancy grid.

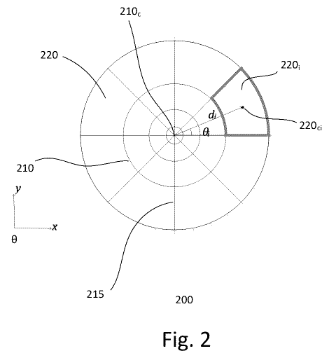

FIG. 2 shows an exemplary embodiment of a polar occupancy grid 200 which represents a pedestrian's surrounding space. In one embodiment, the polar occupancy grid is a dynamic occupancy grid corresponding to a pedestrian's surrounding space. The dynamic occupancy grid divides the pedestrian's surrounding space into concentric rings 210 with discrete angular zones or cells 220. Any cell within the polar occupancy grid can be defined by its respective polar coordinates [x, y, θ] corresponding to x, y and angular axis θ. A center 210c of the polar grid corresponds to the pedestrian at time step t₀. The outermost ring of polar occupancy corresponds to tₓ, where x is the last time step. For example, the polar occupancy ring corresponds to time steps t₀-tₓ. A time step, for example, corresponds to a prediction step.

In one embodiment, the PMM may be configured with 30-60 time steps which are 0.1 to 05 seconds apart. In one embodiment, the PMM is configured with 40 time steps which are 0.2 seconds apart. Other numbers of time steps at different time gaps may also be useful. The number of time steps and time gaps may, for example, depend on the location, such as vehicle speed and pedestrian traffic of the location as well as safety specifications or requirements of the application.

As discussed, the polar occupancy grid is divided into discrete angular cells. For example, the occupancy grid is divided into concentric rings 210 extending out from the center and radial lines 215 which are equally and angularly spaced apart crossing the center of the grid to form discrete angular cells 220 within the concentric rings. The width of the rings is determined according to the uncertainty of the pedestrian's position at each prediction step (time step). For example, the concentric rings become wider as they are further from the grid's center since the uncertainty of the pedestrian's position increases the farther away the pedestrian is from the center. The discrete angular cells are fixed and help to discretize the space for tractability purposes.

In constructing the dynamic polar occupancy grid, two factors play a significant role in predicting a pedestrian's trajectory. These two factors are the speed and the heading of the pedestrian. The PMM assumes that the pedestrian will maintain its heading and speed for predicting the pedestrian's trajectory. Contextual and external factors may produce repelling and attracting forces which may cause a change in the pedestrian's trajectory. Such contextual or external factors include, for example, obstacles (repelling force) blocking some of the grid's cells or proximity to a zebra crossing (attracting force) towards the cells overlapping with it.

As shown, the exemplary polar occupancy grid includes four concentric rings 210 and four radial lines 215, producing eight angular zones within each concentric ring. For example, the radial lines are spaced apart by 45°. Other granularities of angular zones may also be useful. For example, the radial lines may be spaced apart by 10-20°, producing more discrete angular zones. In other embodiments, the radial lines may be spaced from 10-45°. In addition, the polar grid may include other numbers of concentric rings, as already discussed. For example, a greater number of time steps may be represented by the polar occupancy grid.

The predicted trajectory of a pedestrian is represented by the occupancy probability of the cells in the polar grid. The occupancy probability is calculated by independently analyzing the angular motion (related to heading) and the radial motion (related to speed) of the pedestrians to compute two distinct probability distributions that would later be combined to calculate the occupancy probability of a cell.

As an example, a given polar cell 220; (highlighted) can be denoted as L xᵢ∈R²={(dᵢ, θᵢ): dᵢ∈R⁺<∞, −π<θᵢ<π}, where dᵢ is the distance measured from the origin of the grid (enter of the grid) to the center 220_{ci} of the cell 220; and θᵢ is the angle that bisects the angular region of the cell. For example, center 220_{ci} is represented by the polar coordinates [xᵢ, yᵢ, θᵢ]. For example, cells can be designated by their respective polar coordinates. The future positions of the pedestrian in the polar occupancy grid can be indicated as xₜ=(dᵢ, θₜ) where t is the prediction time step.

Using the Bayes filter formulation, and assuming the occupancy probability, which is the belief, of the cell xₜ at prediction step t is conditioned on the measurement z₀¹, the following Equation 1 is obtained:

$$bel ( {x}_{t} ) = p ( {x}_{t} \vert {z}_{0} ) = p ( {d}_{t} , {θ}_{t} \vert {d}_{0}^{z} , {v}^{z} , {θ}_{0}^{z} ) = p ( {d}_{t} \vert {d}_{0}^{z} , {v}^{z} ) p ( {θ}_{t} \vert {θ}_{0}^{z} ) , \qquad ( Equation 1 )$$

where
d₀^{z} is related to the measured initial position of the pedestrian,
v^{z} is the measured speed of the pedestrian, and
θ₀^{z} is the measured heading of the pedestrian.

In the most right-hand side of Equation 1, the first term is related to the pedestrian's speed and prediction time step, which is the radial motion and the second term addresses the pedestrian's heading or angular motion. The rationale for treating these two processes independently stems from the holonomic nature of the motion of pedestrians.

To account for the erratic behavior of humans and the measurement noise, the angular motion term can be transformed into an iteration process of heading estimation and correction as follows:

$$bel ( {θ}_{t} ) = p ( {θ}_{t} \vert {θ}_{0}^{z} ) = η p ( {θ}_{t}^{z} \vert {θ}_{t} ) {\sum }_{{θ}_{t - 1}} p ( {θ}_{t} \vert {θ}_{t - 1} ) p ( {θ}_{t - 1} \vert {θ}_{t - 1}^{z} ) = η p ( {θ}_{t}^{z} \vert {θ}_{t} ) {\sum }_{{θ}_{t - 1}} p ( {θ}_{t} \vert {θ}_{t - 1} ) b e l ( {θ}_{t - 1} ) = η p ( {θ}_{t}^{z} \vert {θ}_{t} ) ( {θ}_{t} ) . \qquad ( Equation 2 )$$

From the perspective of a constant heading postulate, we define θₜ^{z}=θ₀^{z}. The constant η is a normalization term. The state transition probability p (θₜ|θₜ₋₁) is used to assess the probability of a pedestrian moving from cell xₜ₋₁ into a future cell xₜ. As for p(θₜ^{z}|θₜ), it is the measurement model and [symbol] (θₜ) is the estimation of bel(θₜ) before correction at the measurement step. For initialization purposes, bel(θ₀) can be assumed to follow a uniform distribution.

The angular motion probability of the PMM accounts for the pedestrian's heading. In accordance with one embodiment, following the Bayesian filtering formulation and assuming a normal distribution, the state transition probability from one angular region to the next can be represented as Equation 3 below:

$$p ( {θ}_{t} \vert {θ}_{t - 1} ) = \frac{1}{σθ \sqrt{2 π}} {exp}^{- \frac{1}{2} {( \frac{{θ}_{t} - {θ}_{t - 1}}{σ θ} )}^{2}} , \qquad ( Equation 3 )$$

where
σ_{θ} is a hyper-parameter related to the noise of the pedestrian's motion.
   For example, the higher the value of σ_{θ}, the higher the tolerance to the pedestrian changing between two nonadjacent angular regions. On the other hand, the lower the values of σ_{θ}, the probability of such big changes will be reduced.

The measurement probability model is also assumed to follow a normal distribution as expressed in Equation 4 below:

$$p ( {θ}_{t}^{z} \vert {θ}_{t} ) = \frac{1}{{σ}_{θ}^{z} \sqrt{2 π}} {exp}^{- \frac{1}{2} {( \frac{{θ}_{t}^{z} - {θ}_{t}}{{σ}_{θ}^{z}} )}^{2}} , \qquad ( Equation 4 )$$

where
θₜ^{z} is the pedestrian's measured heading, and
σ_{θ}^{z} is a hyper-parameter related to the measurement noise.
   Higher values of σ_{θ}^{z} indicate poor quality of heading measurements and affect the rate of convergence of the filter to the pedestrian's true heading.

In view of Equations 3 and 4, the angular motion (or angular cell) probability can be computed as Equation 5 below:

$$( {θ}_{t} ) = {\sum }_{{θ}_{t - 1}} {p}_{trunc} ( {θ}_{t} \vert {θ}_{t - 1} ) b e l ( {θ}_{t - 1} ) \qquad ( Equation 5 )$$

$$bel ( {θ}_{t} ) = η {p}_{trunc} ( {θ}_{t}^{z} \vert {θ}_{t} ) ( {x}_{t} ) .$$

Note that, given θₜ∈[−π,π], Equation 5 uses truncated versions of Equations 3 and 4. Furthermore, Equation 4 guarantees the conditions for the cumulative distribution functions.

As for the radial motion probability, it accounts for the change in the pedestrian's distance to the grid's center across the prediction time horizon (time steps). In other words, how far the pedestrians are predicted to move from their current position. Given the measured speed and initial position, we determine a probability distribution to estimate the likelihood of such a displacement. Again, we assume that the probability distribution is a Gaussian distribution as follows:

$$p ( {d}_{t} \vert {d}_{0} , v ) = \frac{1}{{σ}_{{d}_{t}} \sqrt{2 π}} {exp}^{- \frac{1}{2} {( \frac{{d}_{t} - {u}_{t}}{{σ}_{{d}_{t}}} )}^{2}} , \qquad ( Equation 6 )$$

where
σ_{d}_{ₜ} is the uncertainty of the displacement dₜ.

Since no further information is given on the mean μₜ and no measurement can be done for the predicted displacement dₜ, a reasonable assumption for Equation 6 would be that dₜ=μₜ. This would result in Equation 7 as follows:

$$p ( {d}_{t} \vert {d}_{0} , v ) = \frac{1}{{σ}_{{d}_{t}} \sqrt{2 π}} . \qquad ( Equation 7 )$$

Equation 7 describes a uniform distribution for dₜ∈[0,σ_{d}_{ₜ}\sqrt{2π}].

Solving for Equation 7, uncertainty σ_{d}_{ₜ} needs to be computed. To compute for uncertainty σ_{d}_{ₜ}. the uncertainty propagation principle can be employed to exploit the knowledge of the initial position uncertainty σ_{d}_{₀} and the measured speed uncertainty σᵥ. Given the kinematic model where dₜ=d₀+υt, Equation 8 below is obtained:

$${σ}_{{d}_{t}} = \sqrt{{σ}_{{d}_{0}}^{2} + {t}^{2} {σ}_{υ}^{2}} , \qquad ( Equation 8 )$$

Although the numerical values of σ_{d0} and σᵥ are related to the quality of the setup of the sensors, they can also be chosen or fine-tuned according to the safety requirements or desired specifications.

After determining the angular and radial motion probabilities, the predicted position can be calculated using Equation 1 by combining the angular and radial motion probabilities, as represented by Equation 9 below:

$$p ( {x}_{t} \vert {x}_{t - 1} ) = η p ( {d}_{t} \vert {d}_{0} , v ) be l ( {θ}_{t} ) . \qquad ( Equation 9 )$$

The occupancy grid cells are populated with the probabilities of the future position of the pedestrian. Given the probability distribution of the different positions at different time steps, the predicted trajectory is calculated using Equation 10 as follows:

$${x}_{P r e d} = {\sum }_{{x}_{t}} p ( {x}_{t} \vert {x}_{t - 1} ) {x}_{t} , \qquad ( Equation 10 )$$

where
x_{pred} refers to the polar coordinates of the particular probability zone (angular cell). With a predicted position obtained from Equation 10, additional contexts or constraints can be applied to the predicted position for a better prediction of the pedestrian's trajectory. For example, contexts or constraints can be used to eliminate or increase the probability of cells for the pedestrian's predicted trajectory.

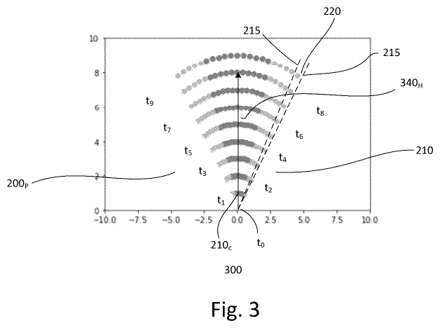

The probability distribution of the cells is a weighted average probability distribution. FIG. 3 shows an example of a weighted average probability distribution 300 of a portion 200_{P} of a polar occupancy grid obtained from Equation 10. The portion, for example, corresponds to a heading of the pedestrian, indicated by arrow 340H. The portion includes rings 210 corresponding to the time steps. As shown, a center 210c of the polar occupancy grid corresponds to time step t₀ and rings extend outwards to the ring corresponding to time step t₀. The rings include angular cells 220. For example, dots on each ring correspond to angular cells of the time step. An angular cell is separated from adjacent cells by adjacent radial lines 215 (dotted lines extending from the center).

As shown, cells proximate to the heading of the pedestrian have higher weighted probabilities than those farther away from the pedestrian's heading, as indicated by the varying densities. For example, the higher weighted probabilities are represented by denser regions, the intermediate weighted probabilities are represented by moderately dense regions and the lowest weighted probabilities are represented by less dense regions. Other configurations for displaying the probabilities may also be useful.

As discussed, the predicted position obtained from Equation 10 can be enhanced. In one embodiment, additional contexts or constraints can be applied to the predicted position to improve the prediction of the pedestrian's trajectory.

A constraint is implemented in Equation 11 below:

$$p ( {x}_{t} \vert {x}_{t - 1} ) = 0 , \qquad ( Equation 11 )$$

where
xₜ refers to the polar coordinates of the pedestrian.
   Equation 11 models the behavior that the probability of a pedestrian colliding with the Ego vehicle is zero. This is because if the pedestrian overlaps with the Ego vehicle on the same cell, the probability of the pedestrian being in that cell would be zero. The assumption is that the pedestrian will not intentionally move towards the same space as the Ego. Even if the pedestrian is moving toward the Ego vehicle, the pedestrian will curve its trajectory when it is closer to the Ego vehicle. Although the constraint described is a collision constraint, other types of constraints may also be useful to eliminate cells from the polar occupancy grid as a possibility of the predicted trajectory. For example, buildings (excluding the entrances), immovable objects as well as other obstacles.

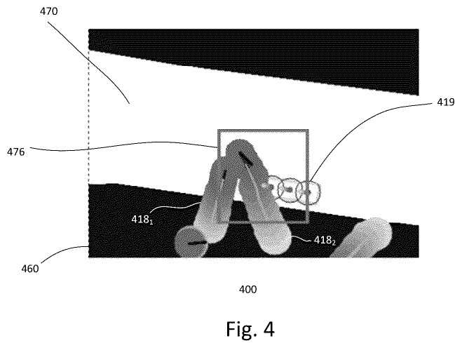

FIG. 4 illustrates an example 400 of an obstacle constraint. The example illustrates a vehicle 419 traveling on a road 470. First and second pedestrians 418₁₋₂ are on a sidewalk 460. The pedestrians, as shown, are on a collision path with the vehicle at a polar grid cell 476 with the vehicle. As discussed, the constraint is that the probability that the pedestrians will occupy this cell at collision time t_{c} will be zero according to Equation 11.

In one embodiment, curb contextual information is also used to improve the prediction of the pedestrian's position. To model curb contextual information, Equations 12 and 13 below are employed:

$${p}^{′} ( {x}_{t} \vert {x}_{t - 1} ) = p ( {x}_{t} \vert {x}_{t - 1} ) * {γ}_{c u r b} ; and \qquad ( Equation 12 )$$

$${p}^{′} ( {x}_{t} \vert {x}_{t - 1} ) = p ( {x}_{t} \vert {x}_{t - 1} ) * {γ}_{r o a d} , \qquad ( Equation 13 )$$

where
γ_{curb} is the pre-determined transition probability from curb to road, and
γ_{road} is the pre-determined transition probability from road to road.
   In one embodiment, if the pedestrian is on the curb and if the pedestrian is on the road, γ_{road}=0.7.

The pre-defined values assigned to γ_{curb} and γ_{road} are based on the assumption that a pedestrian, in general, will stay on the curb and sidewalks instead of intentionally walking on the roads for a prolonged period. The selected pre-defined values model this behaviour of the pedestrians.

In another embodiment, a heatmap prior is employed to improve prediction capabilities. In one embodiment, the heatmap prior is based on statistical information. For example, a statistical heatmap prior H_{S} is employed. The statistical heatmap prior H_{S} is based on the assumption that pedestrians will have a tendency to move towards or along areas of high pedestrian traffic as these areas are generally more traveled by pedestrians as compared to areas with low pedestrian traffic. For example, H_{S} is a uniform distribution of pedestrian trajectories. Based on this assumption, the statistical pedestrian trajectories can be decomposed into a heatmap H_{S} that describes the statistical paths of pedestrians.

In one embodiment, the statistical heatmap prior H_{S} can be constructed based on a piecewise function G(xₜ) below:

$$G ( {x}_{t} ) = \{ \begin{matrix}0 , & {x}_{t} \neq {H}_{x , y} \\ 1 , & {x}_{t} \neq {H}_{x , y}\end{matrix} . \qquad ( Equation 14 )$$

For example, the statistical heatmap prior H_{S} can be constructed, given a polar coordinate on the statistical dataset, H_{x,y}, as follows:

$${H}_{s} = {\sum }_{n = 1}^{k} {\sum }_{t}^{j} G ( {x}_{n , t} ) \qquad ( Equation 15 )$$

The constructed statistical heatmap prior H_{S} is based on a uniform distribution. In one embodiment, the prediction capabilities can be further improved by using an actual past dataset of pedestrians' movements instead of a uniform distribution. Using actual past data of pedestrians increases the accuracy of bel(x₀) compared to a uniform distribution. For example, given a pedestrian location x₀, by taking an area of a pre-determined size, such as 20 by 20 meters, around the pedestrian, the cropped heatmap prior map H″ can be reduced into an angular zone formed by Equations 16 and 17 below:

$$Set ( {α}_{n} ) = \{ {H}_{d , θ}^{″} \vert {θ}_{α}^{l o w e r} < {θ}_{{H}^{″}} < {θ}_{α}^{u p p e r} \} ; and \qquad ( Equation 16 )$$

$$bel ( {x}_{0} ) = η S e t ( α ) . \qquad ( Equation 17 )$$

Equation 16 is used to find the angular zone to assign the Heatmap cell and Equation 17 is used to normalize the entire set of angular zones to obtain the initial belief (prediction heading and position of the pedestrian) of x₀. This results in a more accurate trajectory prediction by the heatmap.

The heatmap prior can also be improved by being treated as an additional sensor measurement and fused at every iteration of the PMM to include contextual information about where the pedestrian might go in the future. Implementing a heatmap prior at every time step also further prevents the decay of information from the heatmap prior if the heatmap is only used to initialize the pedestrian at the first iteration of PMM.

For example, a conditioning of the probability matrix can be performed using information from the heatmap before each time step of Equation 16. In other words, Equation 16 is iterated over the cropped heatmap prior H″ around the pedestrian. This further enhances the implementation of the heatmap prior to every time step. For example, the heading of the pedestrian is used to constrain certain parts of the heatmap prior with respect to the pedestrian. The assumption made is that pedestrians will not move in the opposite heading direction that they are facing. As such, this removes the heatmap cells that are close to the current pedestrian but are in the opposite heading direction. The cosine function used to implement this assumption is represented by Equation 18 below:

$$b e l ( {x}_{t} ) = {d}_{c o s} η p ( b e l ( {x}_{t - 1} ) \vert {c}_{t - 1} ) p ( {c}_{t} \vert {c}_{t - 1} ) p ( {c}_{t - 1} ) p ( {x}_{t} ) , \qquad ( Equation 18 )$$

where

cₜ refers to the contextual information at timestep t, and

$${θ}_{diff} = \vert {θ}_{prior} - {θ}_{i} \vert \qquad ( Equation 19 )$$

$${d}_{cos} \{ \begin{matrix}0 , & cos ( {θ}_{diff} ) < 0 \\ cos ( {θ}_{diff} ) , & cos ( {θ}_{diff} ) < 0\end{matrix} ,$$

where
θ_{diff} refers to the difference of the prior heading and the measured.

In one embodiment, the probability of the predicted position is normalized at each time step using Equation 20 below:

$${p}^{′} ( {x}_{t} ) = η p ( {x}_{t} ) \qquad ( Equation 20 )$$

Normalizing the probability at each time step ensures that the probabilities of the predicted position still sum to one after implementing all the constraints and contextual information.

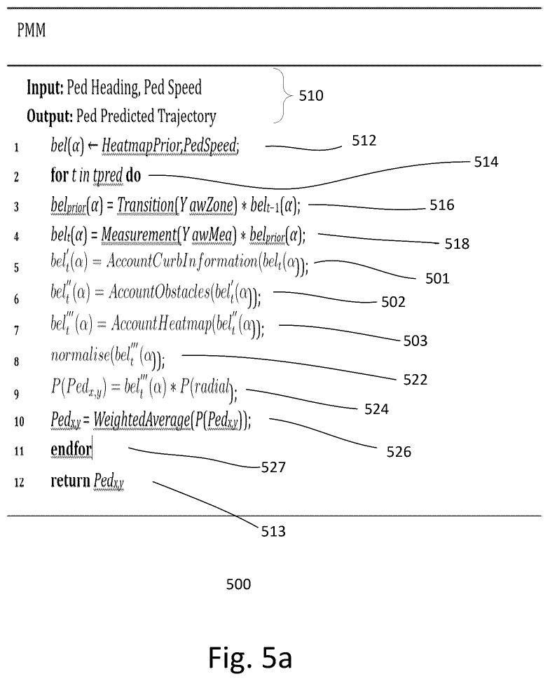

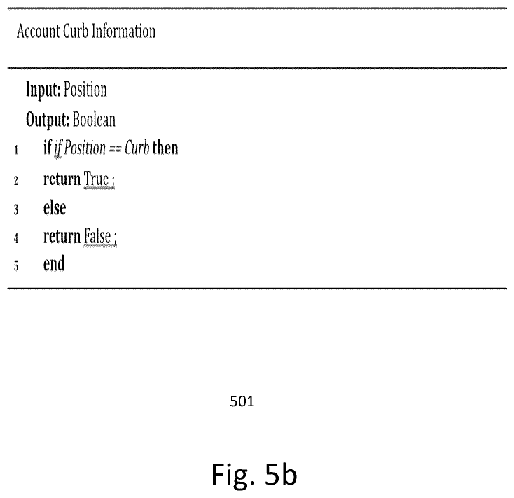

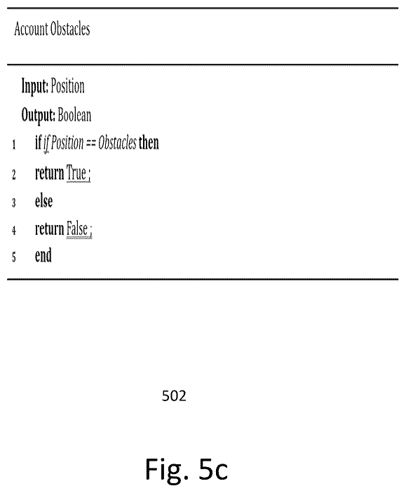

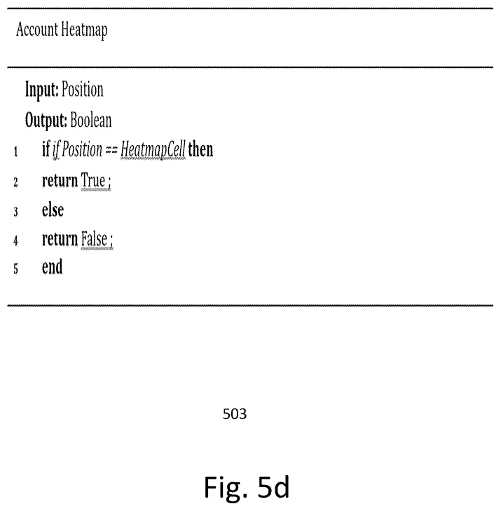

FIGS. 5a-5d show the pseudocode of various PMM processes. FIG. 5a shows the main PMM process pseudocode 500, FIG. 5b shows an account curb information process pseudocode 501, FIG. 5c shows an account obstacles process pseudocode 502 and FIG. 5d shows an account heatmap process pseudocode 503. The various processes are, for example, embodied as computer programs to run on the processor module of the PTP system.

Referring to FIG. 5a, the pseudocode 500 of the main PMM process flow is shown. The process flow receives inputs and generates outputs at 510. In one embodiment, the process flow is configured to receive inputs regarding pedestrians and their headings (a) and speed (v) based on their locations (origin) from the sensor system. For example, the inputs to the PMM process flow are based on perceived information from the sensor system. The PMM process flow generates outputs related to the pedestrians' predicted trajectories. For each pedestrian, the process flow generates a predicted trajectory of that pedestrian based on their headings and speed from perceived information. The PMM flow is repeated for each pedestrian.

At 512, the PMM is initialized to determine a heading and speed of a pedestrian of interest based on the input and a heatmap prior. In one embodiment, the heatmap prior is a statistical heatmap prior H_{S}. Initializing the PMM produces an initial heading based on a uniform distribution. In some embodiments, the PMM is initialized with a heatmap prior based on actual past pedestrian information. Using the heatmap prior with actual past pedestrian information modifies the uniform distribution belief. For example, the heatmap information is used to assign more weight to those cells within the heatmap. As such, the polar grid's cells occupancy probability does not follow a uniform distribution. The initialization of the PMM using the heatmap prior produces a more accurate prediction of the initial pedestrian's heading compared to the use of a uniform distribution.

The process flow, at 514 continues in a loop for each time step. The loop terminates when the time step=tpred, which is the last time step. The loop includes, at 516, determining the angular motion probability of the prior time step (belₚᵣᵢₒᵣ(α)) based on the previous belₜ₋₁(α) without heatmap or context information to continue to the next cell at the same angle α. For example, belₚᵣᵢₒᵣ(α) is the probability of the pedestrian changing direction based on belₜ₋₁(α) calculated using a motion model (transition). In the case that the time step is the first time step to, belₜ₋₁(α) is the probability determined at 512. Otherwise belₜ₋₁(α)=belₚᵣᵢₒᵣ(α) of the previous time step.

At 518, the PMM determines the angular motion probability of the current time step belₜ(α) based on the angular probability of the previous time step belₚᵣᵢₒᵣ(α) using perception information belₚᵣᵢₒᵣ(α). For example, a measurement model is employed using perception information. The angular motion probabilities are then calculated using contextual information at 501, 502 and 503. For example, the process flow calls routines or objects related to curb information, obstacles and heatmap information at 501, 502 and 503. Each object may modify the angular probability based on the results. For example, bel′ₜ(α) results from the curb information object, bel″ₜ(α) results from the obstacles object and bel′″ₜ(α) results from the heatmap object. At 522, the angular motion probability bel′″ₜ(α) is normalized. For example, the angular motion probability is normalized using Equation 19. The normalized angular motion probability is then combined with the radial motion probability at 524 to produce the prediction position of the pedestrian P(Ped_{x,y}) at the current time step.

At 526, a weighted average of P(Ped_{x,y}) of the current time is calculated. If there are more time steps to process, the flow returns to 514 and continues until all time steps have been processed. When all time steps have been processed, the flow outputs P(Ped_{x,y}) at 513.

The output of the main PMM process flow may be analyzed by the processing module to determine if P(Ped_{x,y}) will collide with the Ego. For example, if a pedestrian doesn't curve the trajectory at the last moment, the processing module may cause an alarm warning to be issued to inform the driver of the AV that there is a potential danger of collision. In some cases, the warning may cause the AV control system to slow down or stop to avoid colliding with the pedestrian.

Referring to FIG. 5b, the pseudocode 501 for the curb information process flow is shown. The curb information process flow is configured to receive the current position of the pedestrian from the main PMM flow. Based on the current position of the pedestrian, the curb information flow determines if the pedestrian is on the curb or not. The curb information flow, in one embodiment, returns true if the pedestrian's current position is on the curb or false if not. Curbs, for example, represent an attracting force, making the occupancy of the cell possible, and increasing its probability of being occupied.

FIG. 5c shows the pseudocode 502 for the obstacle information process flow. The obstacle information process flow is configured to receive the current position of the pedestrian from the main PMM flow. Based on the current position of the pedestrian, the heatmap information flow determines if the pedestrian's position is towards a repelling force or an attracting force. If the position of the pedestrian is towards an attracting force, the heatmap flow returns true, otherwise, the flow returns false. An attracting force increases the likelihood that the pedestrian will occupy the cell.

FIG. 5d shows the pseudocode 503 for the heatmap information process flow. The heatmap information process flow is configured to receive heatmap information based on actual past pedestrian data regarding pedestrian movements. If the cell is within the heatmap, the heatmap information flow returns true, otherwise, it returns false. The heatmap information flow increases the likelihood of the pedestrian occupying the cell if it is within the heatmap information.

The PMM makes use of the Bayesian update rule to constantly update the probabilistic states of the path and trajectory of the pedestrian. The initial states, for example, may be initialized with prior knowledge of the system based on a heatmap prior. If there is no prior knowledge, a uniform distribution is used to initialize the angular probability bel(α). Thereafter, time steps are looped through until all time steps are analyzed, while updating bel(α), calculating the agent's position probability P(β) and inserting some variation to the speed and yaw of the agent.

The present disclosure may be embodied in other specific forms without departing from the spirit or essential characteristics thereof. The foregoing embodiments, therefore, are to be considered in all respects illustrative rather than limiting the invention described herein. The scope of the invention is thus indicated by the appended claims, rather than by the foregoing description, and all changes that come within the meaning and range of equivalency of the claims are intended to be embraced therein.

What is claimed is:

1. A system for collision avoidance by an autonomous vehicle (AV) comprising:
a sensor system for detecting objects in the proximity of the AV, the sensor system includes a processing module for processing sensor information from sensor modules; and
a pedestrian trajectory prediction (PTP) system for predicting a trajectory of a pedestrian, the PTP system comprises
an input module, the input module is configured to receive input information captured by the sensor system, wherein the input information also includes a heatmap prior information, wherein the heatmap prior information includes a past dataset of a pedestrian's trajectory tendencies,
a memory module, the memory module is configured to store the input information,
a probabilistic motion model (PMM) module, the PMM module is configured with a PMM, the PMM includes a dynamic polar occupancy grid wherein the predicted trajectory of the pedestrian is represented by an occupancy probability of cells in the polar grid calculated based on
an angular motion probability related to a pedestrian's heading, and
a radial motion probability related to a pedestrian's speed and a distance the pedestrian is predicted to move from a current position, and
wherein a predicted position of the pedestrian can be determined by combining the angular and radial motion probabilities, and
a processing module, the processing module retrieves the information stored in the memory module and processes it using the PMM of the PMM module and generates a warning signal output by an output module to a user interface of the AV if there is an imminent collision with the pedestrian's trajectory.
